(19) United States
(12) Patent Application Publication
(10) Pub. No.: US 2025/0373887 A1
(43) Pub. Date: Dec. 4, 2025

(54) VIDEO CACHING METHOD AND DEVICE

(71) Applicant: Beijing Zitiao Network Technology Co., Ltd., Haidian District (CN)

(72) Inventors: Guanyan Peng, Beijing (CN); Zhiwei Fan, Beijing (CN); Tong Liu, Beijing (CN); Tianze Yu, Beijing (CN); Qing Huang, Beijing (CN); Ruigang Wang, Beijing (CN)

(21) Appl. No.: 19/197,539

(22) Filed: May 2, 2025

(30) Foreign Application Priority Data
May 31, 2024 (CN) 202410703290.X

(51) Int. Cl. H04N 21/433; H04N 21/442; H04N 21/647

(52) U.S. Cl. CPC H04N 21/4331; H04N 21/44204; H04N 21/64738

(57) ABSTRACT

Embodiments of the present disclosure provide a video caching method and device. The method obtains a video bit rate corresponding to a video to be cached, lag data of a plurality of downloaded videos, an estimated network speed value and a first estimated viewing duration, wherein the first estimated viewing duration is obtained based on a current play progress of the video to be cached, and the estimated network speed value is determined based on network speed values of a plurality of pieces of downloaded data during download. A target cache progress of the video to be cached is determined according to the video bit rate, the lag data, the estimated network speed value and the first estimated viewing duration, and a cache progress of the video to be cached is controlled according to the target cache progress.

### CROSS-REFERENCE TO RELATED APPLICATION(S)

This application claims priority to Chinese Application No. 202410703290.X filed on May 31, 2024, the disclosures of which are incorporated herein by reference in their entireties.

### FIELD

Embodiments of the present disclosure relate to the field of computer and network communication technologies, in particular to a video caching method and device.

### BACKGROUND

During video play, a pre-cached video length is a key factor to be balanced.

### SUMMARY

Embodiments of the present disclosure provides a video caching method and device.

In a first aspect, embodiments of the present disclosure provide a video caching method, comprising:
obtaining a video bit rate corresponding to a video to be cached, lag data of a plurality of downloaded videos, an estimated network speed value and a first estimated viewing duration, wherein the first estimated viewing duration is obtained by inputting a current play progress of the video to be cached into a play duration prediction model, the estimated network speed value is determined based on network speed values of a plurality of pieces of downloaded data during download, and the play duration prediction model is obtained through training based on a plurality video play data;
determining a target cache progress of the video to be cached according to the video bit rate, the lag data, the estimated network speed value and the first estimated viewing duration;
controlling a cache progress of the video to be cached according to the target cache progress.

In a second aspect, embodiments of the present disclosure provide a video caching device, comprising:
an obtaining unit for obtaining a video bit rate corresponding to a video to be cached, lag data of a plurality of downloaded videos, an estimated network speed value and a first estimated viewing duration, wherein the first estimated viewing duration is obtained by inputting a current play progress of the video to be cached into a play duration prediction model, the estimated network speed value is determined based on network speed values of a plurality of pieces of downloaded data during download, and the play duration prediction model is obtained through training based on a plurality video play data;
a determining unit for determining a target cache progress of the video to be cached according to the video bit rate, the lag data, the estimated network speed value and the first estimated viewing duration;
a control unit for controlling a cache progress of the video to be cached according to the target cache progress.

In a third aspect, embodiments of the present disclosure provide an electronic device: comprising: a processor and a memory;
where the memory stores computer-executable instructions;
the processor executes the computer-executable instructions stored in the memory, such that the at least one processor performs the video caching method according to the above first aspect and various possible designs thereof.

In a fourth aspect, according to one or more embodiments of the present disclosure, there is provided a computer-readable storage medium stored with computer-executable instructions, which computer-executable instructions, when executed by a processor, implement the video caching method according to the above first aspect and various possible designs thereof.

In a fifth aspect, according to one or more embodiments of the present disclosure, there is provided a computer program product comprising computer programs, which computer programs, when executed by a processor, implement the video caching method according to the above first aspect and various possible designs thereof.

### BRIEF DESCRIPTION OF THE DRAWINGS

Brief introduction of the drawings required in the following description of the embodiments or the prior art are to be provided below to more clearly explain the technical solutions according to the embodiments of the present disclosure or in the prior art. It is obvious that the following drawings illustrate some embodiments of the present disclosure and those skilled in the art also may obtain other drawings on the basis those illustrated ones without any exercises of inventive work.

FIG. 1 illustrates a schematic flowchart I of the video caching method provided by embodiments of the present disclosure;

FIG. 2 illustrates a schematic diagram of cache progress control;

FIG. 3 illustrates a schematic flowchart II of the video caching method provided by embodiments of the present disclosure;

FIG. 4 illustrates a schematic flowchart III of the video caching method provided by embodiments of the present disclosure;

FIG. 5 illustrates a schematic flowchart IV of the video caching method provided by embodiments of the present disclosure;

FIG. 6 illustrates a structural diagram of a video caching device provided by embodiments of the present disclosure;

FIG. 7 illustrates a structural diagram of an electronic device provided by the embodiments of the present disclosure.

### DETAILED DESCRIPTION OF EMBODIMENTS

For a clearer understanding of objectives, technical solution and advantages of the embodiments of the present disclosure, the technical solution in the embodiments of the present disclosure is to be described clearly and completely below with reference to the drawings in the embodiments of the present disclosure. Apparently, the described embodiments are just a part of the embodiments of the present disclosure, rather than all of them. Other embodiments obtained by those skilled in the art without requiring any exercises of inventive work on the basis of the embodiments in the present disclosure all fall within the protection scope of the present disclosure.

During video play, a pre-cached video length is a key factor to be balanced. If an excessively long length of video is cached, it would cause waste of cache resources, increase server costs and possibly lead to waste of network bandwidth. However, if a too short length of video is cached, it would cause problems such as video playback lag and long loading time when the network is not smooth or the connection is unstable. The user experience is therefore affected.

When the network speed is good and relatively stable, the length of the video cached may be appropriately reduced, to occupy fewer network bandwidths and server resources and improve real-time performance and response speed of the system; on the contrary, if the network speed is bad and fluctuating, the length of the video cached may be properly increased, to effectively fight against issues, such as lags and excessively long loading caused by network instability.

However, a method for adjusting the cache based on the above rules could not fully adapt to complicated and changing network environments. In actual situations, the network speed and the stability usually fluctuate dynamically, and accuracy is always an issue due to various factors.

To provide video-on-demand and live broadcast services to users, a video platform has to face a great challenge of lowering operating costs as much as possible while ensuring service quality. From experience, bandwidth cost of Content Delivery Network (CDN) generated from video services takes up the highest proportion of the total cost and is also a key to cost optimization.

On one hand, network transport structure, resource deployment and scheduling policy may be optimized to make better use of cheap edge network nodes, so as to lower unit bandwidth costs; on the other, policy like download and control may also be optimized to identify and reduce unnecessary traffic waste in video distribution, so as to lower the overall traffic consumption. Compared to lowering the unit bandwidth cost, the reduction of waste rate is a more flexible solution to the cost optimization problem and is also a key subject explored by various video service providers at present.

In video-on-demand service, the most common traffic waste comes from redundant cache left in a player when a user exits in the middle of a video play. In principle, cache in essence fights against network jitters. With a prolonged cache duration, lag rate is generally reduced, but the costs would increase simultaneously. In order to achieve significant cost savings with minimal loss of play experience, it is important and necessary to design a precise play cache control scheme.

The primary issue to be solved by the play cache control policy is how to keep the cache duration within an appropriate range during video play, so as to lower the waste induced by user exit as much as possible. At the meantime, the balance between network jitters and the smoothness of video play should also be considered to avoid a soaring lag rate caused by excessive reduction of cache duration.

A common cache control scheme mainly includes a static watermark control method and a dynamic watermark control method. In the former method, cache progress is maintained at a fixed value during video play. Its principle is simple but less flexible. In implementation, it is also quite difficult to select an optimal static watermark for each video play. The latter method suggests dynamically setting a target cache progress according to signals including network speed and bit rate etc. during video play. For example, the cache may appropriately reduce in case of fast and stable network; and the cache would properly increase when the network speed is bad and fluctuating. The dynamic watermark control method currently is a common option for video service providers. Its effect on one hand depends on rationality of algorithm logic design, and on the other also relies on types and accuracy of input signals.

While addressing the existing technical problem in the prior art, the inventor formulated the following technical concepts: first, a length of time the user will continue to watch the video at any viewing progress may be more accurately predicted according to a certain probability; then the length of time the user will continue to watch the video, the lag history and the predicted network speed in the future may be taken into account to comprehensively evaluate a currently proper target cache progress, so as to timely allocate download resources to download segments of the video that is likely to be watched by the user in the future and reduce the download of the segments of the video that is less likely to be watched. This is closer to an ideal case in which the video is downloaded along with the viewing progress. Accordingly, the play lag rate is effectively reduced and the bandwidth waste is also cut down.

The execution body of the video caching method according to the embodiments of the present disclosure may be an electronic device, such as mobile phone, computer, computing machine, tablet and server etc.

Embodiments of the present disclosure provides a video caching method and device, for solving the technical problem of the established low accuracy in the length of video cached.

Embodiments provide a video caching method and device. The method obtains a video bit rate corresponding to a video to be cached, lag data of a plurality of downloaded videos, an estimated network speed value and a first estimated viewing duration, wherein the first estimated viewing duration is obtained by inputting a current play progress of the video to be cached into a play duration prediction model, the estimated network speed value is determined based on network speed values of a plurality of pieces of downloaded data during download, and the play duration prediction model is obtained through training based on a plurality video play data. The method also determines a target cache progress of the video to be cached according to the video bit rate, the lag data, the estimated network speed value and the first estimated viewing duration and controls a cache progress of the video to be cached according to the target cache progress. In this technical solution, various factors, such as estimated viewing duration, estimated network speed and lag situations, may be comprehensively considered to dynamically adjust the cache situation, enhance accuracy of cache policy, save bandwidth resources and improve user experience.

Implementations of the video caching method, the video caching device and the electronic device involved in the embodiments of the present disclosure are described below. Some examples are provided for illustrative purpose, rather than limitations.

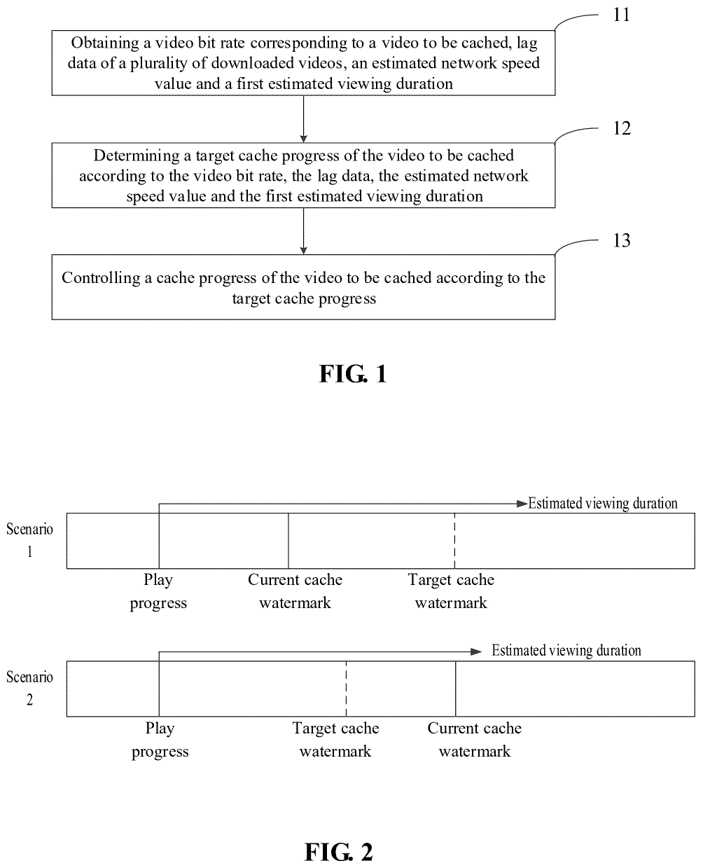

FIG. 1 illustrates a schematic flowchart I of the video caching method provided by embodiments of the present disclosure. As shown in FIG. 1, the video caching method may comprise:

Step 11: obtaining a video bit rate corresponding to a video to be cached, lag data of a plurality of downloaded videos, an estimated network speed value and a first estimated viewing duration;
wherein the first estimated viewing duration is obtained by inputting a current play progress of the video to be cached into a play duration prediction model, the estimated network speed value is determined based on network speed values of a plurality of pieces of downloaded data during download, and the play duration prediction model is obtained through training based on a plurality video play data.

In this solution, ideally, the length of time the user watches the video to be cached can be accurately predicted during video play, and the loading therefore is more pertinent. Although it is difficult to predict an accurate play duration, the problem description can be effectively simplified by introducing the variable of an estimated viewing duration. In other words, a more optimal target cache progress to be solved refers to a cache progress that can support the video to play to an estimated viewing position without lags at the current network speed.

Factors that affect the cache while ensuring no lags in video play also include network speed value. As such, an estimated network speed value is also an element to be obtained for determining subsequent target cache progress; besides, video bit rate indicates the data rate of a video signal in transmission or coding process, and normally is represented in bit per second (bps). The video bit rate denotes the volume of data transmitted per second in the video, i.e., the number of bits included in the video signal within a unit of time. The size of the video bit rate directly affects quality and definition of the video, so it is also required to obtain the video bit rate corresponding to the video to be cached.

Further, it is also required to modify the estimated network speed value using history lag data, to gain a relatively accurate network speed for downloading the current video to be cached (i.e., subsequent target network speed value). The lag data may be the number of lags occurring during the download of a plurality of videos within a preset duration before the current time.

Alternatively, obtaining a first estimated viewing duration may include: acquiring estimated viewing durations corresponding to different probabilities by inputting the current play progress into a pre-trained play duration prediction model; and determining from a plurality of estimated viewing durations an estimated viewing duration as a first estimated viewing duration, which may be an estimated viewing duration with low probability. The play duration prediction model is trained based on a plurality of video play data.

For example, the probability may be 30%. In other words, it is predicted by the play duration prediction model that there is a 30% chance that the user will continue to view the video to be cached for about a first estimated viewing duration, e.g., 30 s.

Wherein a training set of a neural network model corresponding to the play duration prediction model is a plurality of video play data. Certain video play data may be data of a given video that has been played for a first duration according to history and continues to play for a second duration.

In a possible implementation, the user views the video for 12 minutes. By inputting the 12 minutes into the play duration prediction model, it is acquired that the user may continue to view for 30 minutes, i.e., the first estimated viewing duration is 30 minutes and the user continues to view until the 42nd minute.

Alternatively, the estimated network speed value may be obtained based on the preset download network speed values of a plurality of pieces of downloaded data (which may include video, music and file etc.).

In a possible implementation, for example, the network speed values of a plurality of pieces of downloaded data downloaded within a period of time before the current time may be obtained, and an average of these network speed values then serves as the estimated network speed value.

Step 12: determining a target cache progress of the video to be cached according to the video bit rate, the lag data, the estimated network speed value and the first estimated viewing duration;

In this step, after the above video bit rate, lag data, estimated network speed value and first estimated viewing duration are obtained, a relatively stable and reliable network speed estimated value (i.e., subsequently proposed target network speed value) for caching the video to be cached is obtained based on the lag data and the estimated network speed value. Afterwards, a target cache progress of the video to be cached is determined based on the target network speed value, the video bit rate and the first estimated viewing duration.

In this implementation, there are following considerations: first, in case that the play cache reaches the target cache progress and the download of the current video play task immediately starts at this point, the user still can view the video without any lags until an estimated time point even if the download network speed of the user is lower than the video bit rate of the video being played; secondly, the target network speed value is also influenced by history lag statistical state, i.e., it is expected that the target cache progress may be reduced for users with satisfactory network speed and may be increased when history lag increases.

Therefore, a proper target cache progress may be determined in view of the above obtained data.

Step 13: controlling a cache progress of the video to be cached according to the target cache progress.

In this step, the target cache progress, after being determined, is compared with the position of the current cached progress; if the cached progress is ahead of the target cache progress, the electronic device stops caching the video to be cached; if the cached progress is behind the target cache progress, the electronic device continues to cache the video to be cached.

The above determination procedure may be performed in real time or the timing for starting the above determination procedure may be determined according to preset time intervals. The target cache progress also constantly varies to support the user to play the video to be cached without lags.

FIG. 2 illustrates a schematic diagram of cache progress control. As shown, for scenario 1, when the determined target cache progress is ahead of the current cache progress, the execution of the download task continues; for scenario 2, when the determined target cache progress is behind the current cache progress, the execution of the download task suspends.

The video caching method provided by embodiments of the present disclosure obtains a video bit rate corresponding to a video to be cached, lag data of a plurality of downloaded videos, an estimated network speed value and a first estimated viewing duration, wherein the first estimated viewing duration is obtained by inputting a current play progress of the video to be cached into a play duration prediction model, the estimated network speed value is determined based on network speed values of a plurality of pieces of downloaded data during download, and the play duration prediction model is obtained through training based on a plurality video play data; the method also determines a target cache progress of the video to be cached according to the video bit rate, the lag data, the estimated network speed value and the first estimated viewing duration and controls a cache progress of the video to be cached according to the target cache progress. In this technical solution, various factors, such as estimated viewing duration, estimated network speed and lag situations, may be comprehensively considered to dynamically adjust the cache situation, enhance accuracy of cache policy, save bandwidth resources and improve user experience.

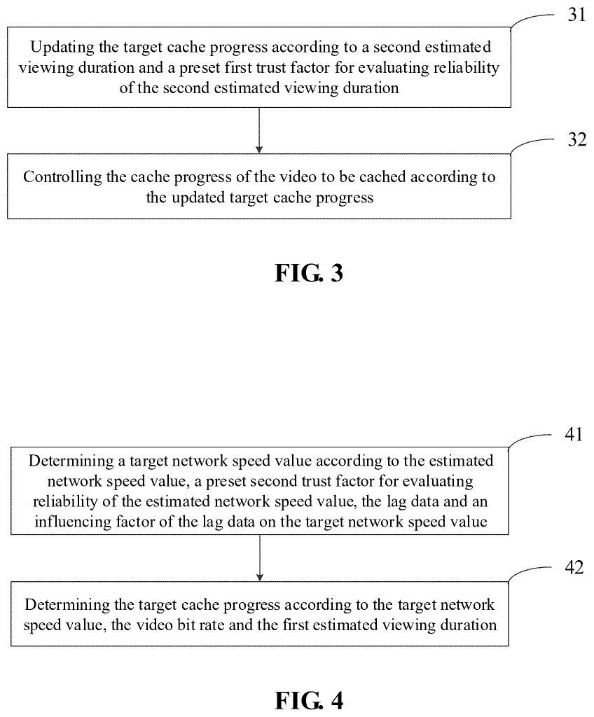

Based on the above embodiment, FIG. 3 illustrates a schematic flowchart II of the video caching method provided by embodiments of the present disclosure. As shown in FIG. 3, the video caching method may comprise:

Step 31: updating the target cache progress according to a second estimated viewing duration and a preset first trust factor for evaluating reliability of the second estimated viewing duration.

Wherein the second estimated viewing duration is obtained by inputting the current play progress into the play duration prediction model, and the second estimated viewing duration output by the play duration prediction model has a probability of occurrence greater than that of the first estimated viewing duration. The first trust factor may be a reliability score of the second estimated viewing duration and is valued between 0 and 1.

Alternatively, the obtaining the second estimated viewing duration may include: inputting the current play progress into the above play duration prediction model to obtain estimated viewing durations corresponding different probabilities; and determining from a plurality of estimated viewing durations an estimated viewing duration with a high probability (the high probability may be greater than the probability corresponding to the above first estimated viewing duration) as the second estimated viewing duration.

For example, the probability may be 70%. In other words, it is predicted by the play duration prediction model that there is a 70% chance that the user will continue to view the video to be cached for about second estimated viewing duration, such as 28 s; in the above implementation, the probability of occurrence corresponding to the first estimated viewing duration is 30%, which is smaller than 70%.

In this implementation, there are following considerations: for the calculation of the target cache progress in view of the network speed in the above embodiments, a relatively high first estimated viewing duration may be predicted according to a relatively low probability, and the predicted value is therefore more conservative to some extent; in terms of modifications in the embodiment, a relatively high probability may be used to predict a slightly short play duration (suggesting that the user is more likely to finish watching), so as to modify the previous target cache progress. With an excessive load amount, the lag is less likely to happen.

In other implementations, each estimated viewing duration may be separately determined according to probability, without defining the size relation between the two.

In this solution, when the target network speed value is larger than or equal to the video bit rate, the target cache progress is no longer affected by the estimated viewing duration. This ignores the factor of user playback behavior to some extent. In addition, the accuracy of the estimated viewing duration has been significantly improved, so the implementation of this step may modify the target cache progress.

Accordingly, the use or weight of the estimated viewing duration may be increased to modify the above obtained target cache progress, such that the intensity of the viewing intention of the user can be sensed under any network speed states. The download of the segments with high viewing probability may be properly increased while the waste is reduced, to optimize the viewing experience of the user.

If the estimated viewing duration is accurate, the target cache progress is directly determined as the estimated viewing duration, so as to ensure that the user can download the data to be played at the fastest speed without causing waste. The final target cache progress value may be a weighted value of the target cache duration and the second estimated play duration, or the maximum value of the two.

As an example, the first trust factor is denoted as wₜᵣᵤₛₜ; the target cache progress is represented by Δtₜₐᵣ; the updated target cache progress is indicated as tₜₐᵣ; and the second estimated viewing duration is Δtₑₛₜ₂.

Alternatively, the step 31 may include the following possible situations:

First, in response to the first trust factor being greater than a first preset value and smaller than a second preset value, the target cache progress is updated to a first value, wherein the first value is a sum of a first sub-value and a second sub-value, the first sub-value is a product of the first trust factor and the second estimated viewing duration, the second sub-value is a product of the target cache progress and a third sub-value, the third sub-value is a difference between 1 and the first trust factor, and the second preset value is greater than the first preset value;

For example, the first sub-value is equal to wₜᵣᵤₛₜ*Δtₑₛₜ₂; the third sub-value is equal to 1−wₜᵣᵤₛₜ; and the second sub-value is Δtₜₐᵣ (1−wₜᵣᵤₛₜ).

Assuming that the first preset value is 0 and the second preset value is 1, when wₜᵣᵤₛₜ is between 0 and 1 (including values of 0 and 1):

$${t}_{tar} = Δ {t}_{tar} * ( 1 - {w}_{trust} ) + {w}_{trust} * Δ {t}_{est 2} .$$

Secondly, in response to the first trust factor not being greater than the first preset value or not being smaller than the second preset value, the target cache progress is updated to a second value, wherein the second value is a maximum value of the target cache progress and the second estimated viewing duration.

Assuming that the first preset value is 0 and the second preset value is 1, when wₜᵣᵤₛₜ is outside 0-1:

$${t}_{tar} = max ( Δ {t}_{tar} , Δ {t}_{est 2} ) .$$

Alternatively, the step 31 may be executed before step 13.

It is to be understood that in comparison to the approach for obtaining the target cache progress in the above embodiment, the implementation of this embodiment takes better use of the second estimated viewing duration and lowers the dependency on the network speed and the demand on accuracy of the network speed prediction.

Step 32: controlling the cache progress of the video to be cached according to the updated target cache progress.

In this step, the updated target cache progress, after being determined, is compared with the position of the current cached progress; if the cached progress is ahead of the updated target cache progress, the electronic device stops caching the video to be cached; if the cached progress is not ahead of the updated target cache progress, the electronic device continues to cache the video to be cached.

Details may refer to the above FIG. 2 and step 32 and the implementation principle is similar.

The video caching method provided by embodiments of the present disclosure updates the target cache progress according to a second estimated viewing duration and a preset first trust factor for evaluating reliability of the second estimated viewing duration, wherein the second estimated viewing duration is obtained by inputting the current play progress into the play duration prediction model, and the second estimated viewing duration output by the play duration prediction model has a probability of occurrence greater than that of the first estimated viewing duration; the method then controls a cache progress of the video to be cached according to the updated target cache progress. In this technical solution, the use or weight of the estimated viewing duration may be increased to modify the above obtained target cache progress, such that the intensity of the viewing intention of the user can be sensed under any network speed states. The download of the segments with high viewing probability may be properly increased while the waste is reduced, to optimize the viewing experience of the user.

Based on the above embodiment, FIG. 4 illustrates a schematic flowchart III of the video caching method provided by embodiments of the present disclosure. As shown, the above step 12 may include:

Step 41: determining a target network speed value according to the estimated network speed value, a preset second trust factor for evaluating reliability of the estimated network speed value, the lag data and an influencing factor of the lag data on the target network speed value;

Wherein the second trust factor may be a preset reliability score of the estimated network speed value; and both the second trust factor and the influencing factor are empirically set.

In this step, first, it is required to evaluate the network speed of the electronic device. Then, based on the estimated network speed value, the second trust factor of the estimated network speed value, the lag data of the electronic device and the influencing factor of the lag data on the target network speed value, a relatively accurate future network speed value, i.e., target network speed value, is determined.

In one possible implementation, the target network speed value is denoted as B_{safe}; the lag data is represented as cs; the influencing factor is indicated as es; the second trust factor is aₜᵣᵤₛₜ; and the estimated network speed value is indicated as B; on this basis, the following equation is provided:

$${B}_{safe} = B * {a}_{trust} / ( 1 + {c}_{s} * {e}_{s} ) .$$

Step 42: determining the target cache progress according to the target network speed value, the video bit rate and the first estimated viewing duration.

In this step, after the target network speed value is obtained, the first estimated viewing duration is processed using the video bit rate of the video to be cached in combination with the target network speed value and the video bit rate, so as to obtain the target cache progress.

Alternatively, the step 42 may be implemented as follows:

First step: determining a maximum value of a third preset value and a fourth sub-value as a first candidate cache progress, wherein the fourth sub-value is determined based on a fourth preset value, the target network speed value, the video bit rate and the first estimated viewing duration;

Wherein the first candidate cache progress is denoted as Δtₜₐᵣ₁; the video bit rate is represented as R, and the first estimated viewing duration is indicated as Δtest1; on this basis, the following equation is provided:

$$Δ {t}_{tar 1} = max ( 0 , ( 1 - {B}_{safe} / R ) * Δ {t}_{est 1} ) .$$

The third preset value may be 0 and the fourth preset value may be 1.

Second step: determining the target cache progress according to the first candidate cache progress, a preset minimum cache progress and a preset maximum cache progress.

Wherein this implementation may include: taking a sum value of the first candidate cache progress and the minimum cache progress as a second candidate cache progress; and taking a minimum value of the second candidate cache progress and the maximum cache progress as the target cache progress.

The second candidate cache progress is indicated as Δtₜₐᵣ₂; the minimum cache progress is denoted as Δtₘᵢₙ; and the maximum cache progress is represented as Δtₘₐₓ; on this basis, the following equation is provided:

$$Δ {t}_{tar 2} = Δ {t}_{tar 1} + Δ {t}_{min}$$

Further, Δtₜₐᵣ=min (Δtₜₐᵣ₂, Δtₘₐₓ).

It is to be appreciated that the maximum cache progress and the minimum cache progress are set to improve accuracy on the basis of the above target network speed value and the estimated viewing duration. To enhance the stability of the implementation procedure, upper and lower limits are added to the target cache progress to avoid outliers.

The video caching method provided by embodiments of the present disclosure determines a target network speed value according to the estimated network speed value, a preset second trust factor for evaluating reliability of the estimated network speed value, the lag data and an influencing factor of the lag data on the target network speed value, wherein the second trust factor is a preset reliability score of the estimated network speed value; then the method determines the target cache progress according to the target network speed value, the video bit rate and the first estimated viewing duration. In this technical solution, by adding the act weight of the estimated network speed value in the calculation of the target cache progress and with reference to the estimated viewing duration, the play cache control logic is overall optimized, such that the control over the target cache progress is more accurate.

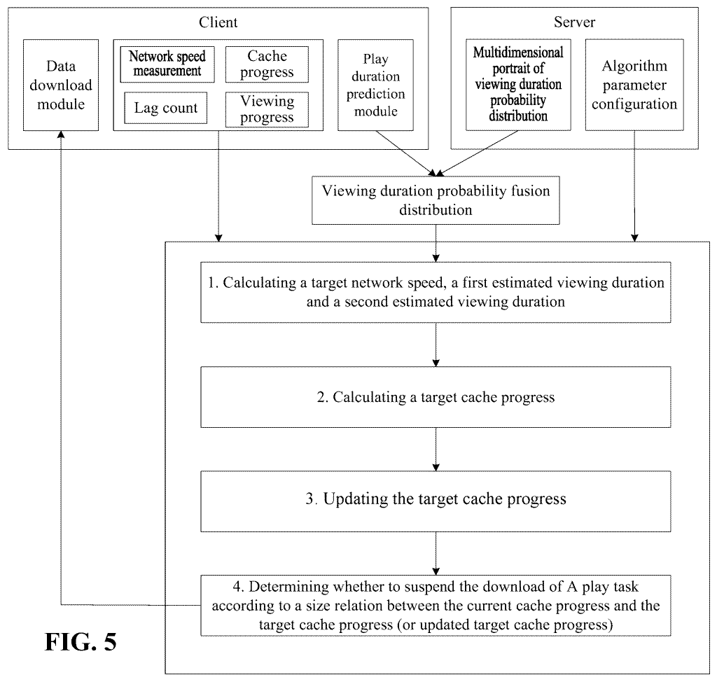

Based on the above embodiment, FIG. 5 illustrates a schematic flowchart IV of the video caching method provided by embodiments of the present disclosure. As shown in FIG. 5, the video caching method may include processing by a client and a server, the client being one kind of the electronic device. The method comprises:
Client: data download module; network speed measurement; cache progress; lag count; viewing progress; play duration prediction module;
Server: multidimensional portrait of viewing duration probability distribution; algorithm parameter configuration;

Specifically, the play cache control policy of the client may include:
1. Calculating a target network speed value;
2. Calculating a target cache progress (involving the first viewing duration);
3. Updating the target cache progress (involving the second viewing duration);
4. Determining whether to suspend the download of the play task according to a size relation between the current cache progress and the target cache progress (or updated target cache progress).

The implementation principles and the technical effects of the video caching method provided by embodiments of the present disclosure are similar to the above technical solution and will not be elaborated here to avoid repetition.

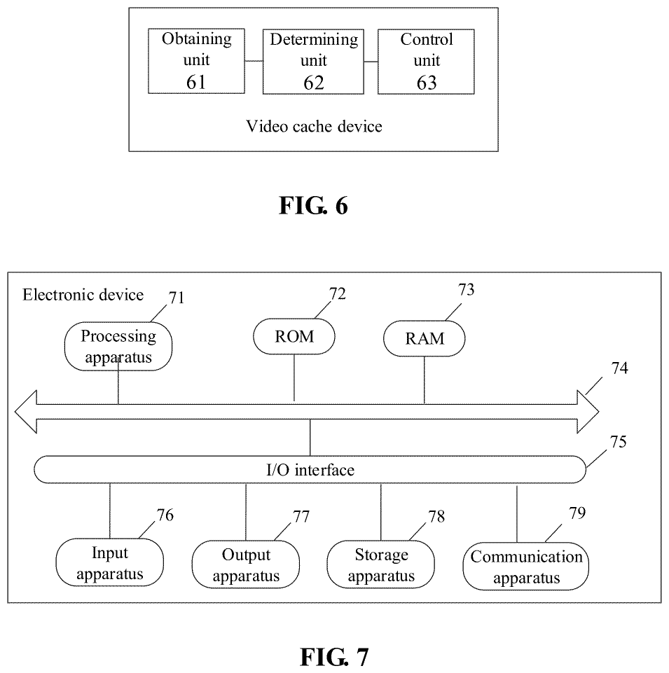

Based on the above method embodiment, FIG. 6 illustrates a structural diagram of a video caching device provided by embodiments of the present disclosure. As shown in FIG. 6, the video caching device comprises:
an obtaining unit 61 for obtaining a video bit rate corresponding to a video to be cached, lag data of a plurality of downloaded videos, an estimated network speed value and a first estimated viewing duration, wherein the first estimated viewing duration is obtained by inputting a current play progress of the video to be cached into a play duration prediction model, the estimated network speed value is determined based on network speed values of a plurality of pieces of downloaded data during download, and the play duration prediction model is obtained through training based on a plurality video play data;
a determining unit 62 for determining a target cache progress of the video to be cached according to the video bit rate, the lag data, the estimated network speed value and the first estimated viewing duration;
a control unit 63 for controlling a cache progress of the video to be cached according to the target cache progress.

According to one or more embodiments of the present disclosure, the determining unit 62 is also provided for:
updating the target cache progress according to a second estimated viewing duration and a preset first trust factor for evaluating reliability of the second estimated viewing duration, to obtain an updated target cache progress, wherein the second estimated viewing duration is obtained by inputting the current play progress into the play duration prediction model, and the second estimated viewing duration output by the play duration prediction model has a probability of occurrence greater than that of the first estimated viewing duration;
controlling the cache progress of the video to be cached according to the updated target cache progress.

According to one or more embodiments of the present disclosure, the updating, by the determining unit 62, the target cache progress according to a second estimated viewing duration and a preset first trust factor for evaluating reliability of the second estimated viewing duration includes:
in response to the first trust factor being greater than a first preset value and smaller than a second preset value, updating the target cache progress to a first value, wherein the first value is a sum of a first sub-value and a second sub-value, the first sub-value is a product of the first trust factor and the second estimated viewing duration, the second sub-value is a product of the target cache progress and a third sub-value, the third sub-value is a difference between 1 and the first trust factor, and the second preset value is greater than the first preset value;
in response to the first trust factor not being greater than the first preset value or not being smaller than the second preset value, updating the target cache progress to a second value, wherein the second value is a maximum value of the target cache progress and the second estimated viewing duration.

According to one or more embodiments of the present disclosure, the determining, by the determining unit 62, a target cache progress of the video to be cached according to the video bit rate, the lag data, the estimated network speed value and the first estimated viewing duration includes:
determining a target network speed value according to the estimated network speed value, a preset second trust factor for evaluating reliability of the estimated network speed value, the lag data and an influencing factor of the lag data on the target network speed value;
determining the target cache progress according to the target network speed value, the video bit rate and the first estimated viewing duration.

According to one or more embodiments, the determining, by the determining unit 62, the target cache progress according to the target network speed value, the video bit rate and the first estimated viewing duration includes:
determining a maximum value of a third preset value and a fourth sub-value as a first candidate cache progress, wherein the fourth sub-value is determined based on a fourth preset value, the target network speed value, the video bit rate and the first estimated viewing duration;
determining the target cache progress according to the first candidate cache progress, a preset minimum cache progress and a preset maximum cache progress.

According to one or more embodiments, the determining, by the determining unit 62, the target cache progress according to the first candidate cache progress, a preset minimum cache progress and a preset maximum cache progress includes:
taking a sum value of the first candidate cache progress and the minimum cache progress as a second candidate cache progress;
taking a minimum value of the second candidate cache progress and the maximum cache progress as the target cache progress.

According to one or more embodiments of the present disclosure, the obtaining the first estimated viewing duration and the second estimated viewing duration by the obtaining unit 61 includes:
inputting the current play progress into the play duration prediction model, to obtain the first estimated viewing duration and the second estimated viewing duration.

The video caching device provided by the embodiments of the present disclosure has similar technical solution and technical effects to those in the above embodiments and will not be elaborated here to avoid repetition.

To implement the above embodiments, embodiments of the present disclosure also provide an electronic device. FIG. 7 illustrates a structural diagram of an electronic device provided by embodiments of the present disclosure.

Wherein the electronic device may include, but not limited to, mobile terminals, such as mobile phones, notebooks, digital broadcast receivers, Personal Digital Assistant (PDA), Portable Android Device (PAD), Portable Multimedia Player (PMP) and vehicle terminals (such as car navigation terminal) and fixed terminals, e.g., digital TVs and desktop computers etc. The electronic device shown in FIG. 7 is just an example and will not put any restrictions on the functions and application ranges of the embodiments of the present disclosure.

According to FIG. 7, the electronic device may include a processing apparatus (e.g., central processor, graphic processor and the like) 71, which can execute various suitable actions and processing based on the programs stored in the read-only memory (ROM) 72 or programs loaded in the random-access memory (RAM) 73 from a storage apparatus 78. The RAM 73 can also store all kinds of programs and data required by the operations of the electronic device. Processing apparatus 71, ROM 72 and RAM 73 are connected to each other via a bus 74. The input/output (I/O) interface 75 is also connected to the bus 74.

Usually, input apparatus 76 (including touch screen, touchpad, keyboard, mouse, camera, microphone, accelerometer, gyroscope and like) and output apparatus 77 (including liquid crystal display (LCD), speaker and vibrator etc.), storage apparatus 78 (including tape and hard disk etc.) and communication apparatus 79 may be connected to the I/O interface 75. The communication apparatus 79 may allow the electronic device to exchange data with other devices through wired or wireless communications. Although FIG. 7 illustrates the electronic device having various units, it is to be understood that it is not a prerequisite to implement or provide all illustrated units. Alternatively, more or less units may be implemented or provided.

In particular, according to embodiments of the present disclosure, the process depicted above with reference to the flowchart may be implemented as computer software programs. For example, the embodiments of the present disclosure include a computer program product including computer programs carried on a computer readable medium, wherein the computer programs include program codes for executing the method demonstrated by the flowchart. In these embodiments, the computer programs may be loaded and installed from networks via the communication apparatus 79, or installed from the storage apparatus 78, or installed from the ROM 72. The computer programs, when executed by the processing apparatus 71, performs the above functions defined in the method according to the embodiments of the present disclosure.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

The above computer readable medium may be included in the aforementioned electronic device or stand-alone without fitting into the electronic device.

The above computer-readable medium carriers one or more programs, where the one or more programs, when executed by the electronic device, cause the electronic device to perform the method shown by the above embodiments.

Computer program instructions for executing operations of the present disclosure are written in one or more programming languages or combinations thereof. The above programming languages include object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit should not be considered as the restriction over the unit per se. For example, the first obtaining unit also may be described as “a unit that obtains at least two internet protocol addresses”.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

In a first aspect, according to one or more embodiments of the present disclosure, a video caching method is provided, comprising:
obtaining a video bit rate corresponding to a video to be cached, lag data of a plurality of downloaded videos, an estimated network speed value and a first estimated viewing duration, wherein the first estimated viewing duration is obtained by inputting a current play progress of the video to be cached into a play duration prediction model, the estimated network speed value is determined based on network speed values of a plurality of pieces of downloaded data during download, and the play duration prediction model is obtained through training based on a plurality video play data;
determining a target cache progress of the video to be cached according to the video bit rate, the lag data, the estimated network speed value and the first estimated viewing duration;
controlling a cache progress of the video to be cached according to the target cache progress.

According to one or more embodiments of the present disclosure, the method further comprises:
updating the target cache progress according to a second estimated viewing duration and a preset first trust factor for evaluating reliability of the second estimated viewing duration, to obtain an updated target cache progress, wherein the second estimated viewing duration is obtained by inputting the current play progress into the play duration prediction model, and the second estimated viewing duration output by the play duration prediction model has a probability of occurrence greater than that of the first estimated viewing duration;
controlling the cache progress of the video to be cached according to the updated target cache progress.

According to one or more embodiments of the present disclosure, updating the target cache progress according to the second estimated viewing duration and the preset first trust factor for evaluating the reliability of the second estimated viewing duration includes:
in response to the first trust factor being greater than a first preset value and smaller than a second preset value, updating the target cache progress to a first value, wherein the first value is a sum of a first sub-value and a second sub-value, the first sub-value is a product of the first trust factor and the second estimated viewing duration, the second sub-value is a product of the target cache progress and a third sub-value, the third sub-value is a difference between 1 and the first trust factor, and the second preset value is greater than the first preset value;
in response to the first trust factor not being greater than the first preset value or not being smaller than the second preset value, updating the target cache progress to a second value, wherein the second value is a maximum value of the target cache progress and the second estimated viewing duration.

According to one or more embodiments of the present disclosure, determining the target cache progress of the video to be cached according to the video bit rate, the lag data, the estimated network speed value and the first estimated viewing duration includes:
determining a target network speed value according to the estimated network speed value, a preset second trust factor for evaluating reliability of the estimated network speed value, the lag data and an influencing factor of the lag data on the target network speed value;
determining the target cache progress according to the target network speed value, the video bit rate and the first estimated viewing duration.

According to one or more embodiments of the present disclosure, determining the target cache progress according to the target network speed value, the video bit rate and the first estimated viewing duration includes:
determining a maximum value of a third preset value and a fourth sub-value as a first candidate cache progress, wherein the fourth sub-value is determined based on a fourth preset value, the target network speed value, the video bit rate and the first estimated viewing duration;
determining the target cache progress according to the first candidate cache progress, a preset minimum cache progress and a preset maximum cache progress.

According to one or more embodiments of the present disclosure, determining the target cache progress according to the first candidate cache progress, the preset minimum cache progress and the preset maximum cache progress includes:
taking a sum value of the first candidate cache progress and the minimum cache progress as a second candidate cache progress;
taking a minimum value of the second candidate cache progress and the maximum cache progress as the target cache progress.

According to one or more embodiments of the present disclosure, obtaining the first estimated viewing duration and the second estimated viewing duration includes:
inputting the current play progress into the play duration prediction model, to obtain the first estimated viewing duration and the second estimated viewing duration.

In a second aspect, according to one or more embodiments of the present disclosure, there is provided a video caching device, comprising:
an obtaining unit for obtaining a video bit rate corresponding to a video to be cached, lag data of a plurality of downloaded videos, an estimated network speed value and a first estimated viewing duration, wherein the first estimated viewing duration is obtained by inputting a current play progress of the video to be cached into a play duration prediction model, the estimated network speed value is determined based on network speed values of a plurality of pieces of downloaded data during download, and the play duration prediction model is obtained through training based on a plurality video play data;
a determining unit for determining a target cache progress of the video to be cached according to the video bit rate, the lag data, the estimated network speed value and the first estimated viewing duration;
a control unit for controlling a cache progress of the video to be cached according to the target cache progress.

According to one or more embodiments of the present disclosure, the determining unit is also provided for:
updating the target cache progress according to a second estimated viewing duration and a preset first trust factor for evaluating reliability of the second estimated viewing duration, to obtain an updated target cache progress, wherein the second estimated viewing duration is obtained by inputting the current play progress into the play duration prediction model, and the second estimated viewing duration output by the play duration prediction model has a probability of occurrence greater than that of the first estimated viewing duration;
controlling the cache progress of the video to be cached according to the updated target cache progress.

According to one or more embodiments of the present disclosure, the updating, by the determining unit, the target cache progress according to a second estimated viewing duration and a preset first trust factor for evaluating reliability of the second estimated viewing duration includes:
in response to the first trust factor being greater than a first preset value and smaller than a second preset value, updating the target cache progress to a first value, wherein the first value is a sum of a first sub-value and a second sub-value, the first sub-value is a product of the first trust factor and the second estimated viewing duration, the second sub-value is a product of the target cache progress and a third sub-value, the third sub-value is a difference between 1 and the first trust factor, and the second preset value is greater than the first preset value;
in response to the first trust factor not being greater than the first preset value or not being smaller than the second preset value, updating the target cache progress to a second value, wherein the second value is a maximum value of the target cache progress and the second estimated viewing duration.

According to one or more embodiments of the present disclosure, the determining, by the determining unit, a target cache progress of the video to be cached according to the video bit rate, the lag data, the estimated network speed value and the first estimated viewing duration includes:
determining a target network speed value according to the estimated network speed value, a preset second trust factor for evaluating reliability of the estimated network speed value, the lag data and an influencing factor of the lag data on the target network speed value;
determining the target cache progress according to the target network speed value, the video bit rate and the first estimated viewing duration.

According to one or more embodiments, the determining, by the determining unit, the target cache progress according to the target network speed value, the video bit rate and the first estimated viewing duration includes:
determining a maximum value of a third preset value and a fourth sub-value as a first candidate cache progress, wherein the fourth sub-value is determined based on a fourth preset value, the target network speed value, the video bit rate and the first estimated viewing duration;
determining the target cache progress according to the first candidate cache progress, a preset minimum cache progress and a preset maximum cache progress.

According to one or more embodiments, the determining, by the determining unit, the target cache progress according to the first candidate cache progress, a preset minimum cache progress and a preset maximum cache progress includes:
taking a sum value of the first candidate cache progress and the minimum cache progress as a second candidate cache progress;
taking a minimum value of the second candidate cache progress and the maximum cache progress as the target cache progress.

According to one or more embodiments of the present disclosure, the obtaining the first estimated viewing duration and the second estimated viewing duration by the obtaining unit includes:
inputting the current play progress into the play duration prediction model, to obtain the first estimated viewing duration and the second estimated viewing duration.

In a third aspect, according to one or more embodiments of the present disclosure, there is provided an electronic device comprising: at least one processor and a memory;
where the memory stores computer-executable instructions;
the at least one processor executes the computer-executable instructions stored in the memory, such that the at least one processor performs the video caching method according to the above first aspect and various possible designs thereof.

In a fourth aspect, according to one or more embodiments of the present disclosure, there is provided a computer-readable storage medium stored with computer-executable instructions, which computer-executable instructions, when executed by a processor, implement the video caching method according to the above first aspect and various possible designs thereof.

In a fifth aspect, according to one or more embodiments of the present disclosure, there is provided a computer program product comprising computer programs, which computer programs, when executed by a processor, implement the video caching method according to the above first aspect and various possible designs thereof.

The above description only explains the preferred embodiments of the present disclosure and the technical principles applied. Those skilled in the art should understand that the scope of the present disclosure is not limited to the technical solution resulted from particular combinations of the above technical features, and meanwhile should also encompass other technical solutions formed from any combinations of the above technical features or equivalent features without deviating from the above disclosed inventive concept, such as the technical solutions formed by substituting the above features with the technical features disclosed here with similar functions.

Furthermore, although the respective operations are depicted in a particular order, it should be appreciated that the operations are not required to be completed in the particular order or in succession. In some cases, multitasking or multiprocessing is also beneficial. Likewise, although the above discussion comprises some particular implementation details, they should not be interpreted as limitations over the scope of the present disclosure. Some features described separately in the context of the embodiments of the description can also be integrated and implemented in a single embodiment. Conversely, all kinds of features described in the context of a single embodiment can also be separately implemented in multiple embodiments or any suitable sub-combinations.

Although the subject matter is already described by languages specific to structural features and/or method logic acts, it is to be appreciated that the subject matter defined in the attached claims is not limited to the above described particular features or acts. On the contrary, the above described particular features and acts are only example forms for implementing the claims.

I/We claim:

1. A video caching method, comprising:
obtaining a video bit rate corresponding to a video to be cached, lag data of a plurality of downloaded videos, an estimated network speed value and a first estimated viewing duration, wherein the first estimated viewing duration is obtained by inputting a current play progress of the video to be cached into a play duration prediction model, the estimated network speed value is determined based on network speed values of a plurality of pieces of downloaded data during download, and the play duration prediction model is obtained through training based on a plurality video play data;
determining a target cache progress of the video to be cached according to the video bit rate, the lag data, the estimated network speed value and the first estimated viewing duration; and
controlling a cache progress of the video to be cached according to the target cache progress.

2. The method of claim 1, wherein the method further comprises:
updating the target cache progress according to a second estimated viewing duration and a preset first trust factor for evaluating reliability of the second estimated viewing duration, to obtain an updated target cache progress, wherein the second estimated viewing duration is obtained by inputting the current play progress into the play duration prediction model, and the second estimated viewing duration output by the play duration prediction model has a probability of occurrence greater than that of the first estimated viewing duration; and
controlling the cache progress of the video to be cached according to the updated target cache progress.

3. The method of claim 2, wherein updating the target cache progress according to the second estimated viewing duration and the preset first trust factor for evaluating the reliability of the second estimated viewing duration comprises:
in response to the first trust factor being greater than a first preset value and smaller than a second preset value, updating the target cache progress to a first value, wherein the first value is a sum of a first sub-value and a second sub-value, the first sub-value is a product of the first trust factor and the second estimated viewing duration, the second sub-value is a product of the target cache progress and a third sub-value, the third sub-value is a difference between 1 and the first trust factor, and the second preset value is greater than the first preset value; and
in response to the first trust factor not being greater than the first preset value or not being smaller than the second preset value, updating the target cache progress to a second value, wherein the second value is a maximum value of the target cache progress and the second estimated viewing duration.

4. The method of claim 1, wherein determining the target cache progress of the video to be cached according to the video bit rate, the lag data, the estimated network speed value and the first estimated viewing duration comprises:
determining a target network speed value according to the estimated network speed value, a preset second trust factor for evaluating reliability of the estimated network speed value, the lag data and an influencing factor of the lag data on the target network speed value; and
determining the target cache progress according to the target network speed value, the video bit rate and the first estimated viewing duration.

5. The method of claim 4, wherein determining the target cache progress according to the target network speed value, the video bit rate and the first estimated viewing duration comprises:
determining a maximum value of a third preset value and a fourth sub-value as a first candidate cache progress, wherein the fourth sub-value is determined based on a fourth preset value, the target network speed value, the video bit rate and the first estimated viewing duration; and
determining the target cache progress according to the first candidate cache progress, a preset minimum cache progress and a preset maximum cache progress.

6. The method of claim 5, wherein determining the target cache progress according to the first candidate cache progress, the preset minimum cache progress and the preset maximum cache progress comprises:
taking a sum value of the first candidate cache progress and the minimum cache progress as a second candidate cache progress; and
taking a minimum value of the second candidate cache progress and the maximum cache progress as the target cache progress.

7. The method of claim 2, wherein obtaining the first estimated viewing duration and the second estimated viewing duration comprises:
inputting the current play progress into the play duration prediction model, to obtain the first estimated viewing duration and the second estimated viewing duration.

8. An electronic device, comprising: a processor and a memory, wherein:
the memory stores computer-executable instructions; and
the processor executes the computer-executable instructions stored in the memory to cause the processor to perform a video caching method comprising:
obtaining a video bit rate corresponding to a video to be cached, lag data of a plurality of downloaded videos, an estimated network speed value and a first estimated viewing duration, wherein the first estimated viewing duration is obtained by inputting a current play progress of the video to be cached into a play duration prediction model, the estimated network speed value is determined based on network speed values of a plurality of pieces of downloaded data during download, and the play duration prediction model is obtained through training based on a plurality video play data;
determining a target cache progress of the video to be cached according to the video bit rate, the lag data, the estimated network speed value and the first estimated viewing duration; and
controlling a cache progress of the video to be cached according to the target cache progress.

9. The electronic device of claim 8, wherein the method further comprises:
updating the target cache progress according to a second estimated viewing duration and a preset first trust factor for evaluating reliability of the second estimated viewing duration, to obtain an updated target cache progress, wherein the second estimated viewing duration is obtained by inputting the current play progress into the play duration prediction model, and the second estimated viewing duration output by the play duration prediction model has a probability of occurrence greater than that of the first estimated viewing duration; and
controlling the cache progress of the video to be cached according to the updated target cache progress.

10. The electronic device of claim 9, wherein updating the target cache progress according to the second estimated viewing duration and the preset first trust factor for evaluating the reliability of the second estimated viewing duration comprises:
in response to the first trust factor being greater than a first preset value and smaller than a second preset value, updating the target cache progress to a first value, wherein the first value is a sum of a first sub-value and a second sub-value, the first sub-value is a product of the first trust factor and the second estimated viewing duration, the second sub-value is a product of the target cache progress and a third sub-value, the third sub-value is a difference between 1 and the first trust factor, and the second preset value is greater than the first preset value; and
in response to the first trust factor not being greater than the first preset value or not being smaller than the second preset value, updating the target cache progress to a second value, wherein the second value is a maximum value of the target cache progress and the second estimated viewing duration.

11. The electronic device of claim 8, wherein determining the target cache progress of the video to be cached according to the video bit rate, the lag data, the estimated network speed value and the first estimated viewing duration comprises:
determining a target network speed value according to the estimated network speed value, a preset second trust factor for evaluating reliability of the estimated network speed value, the lag data and an influencing factor of the lag data on the target network speed value; and
determining the target cache progress according to the target network speed value, the video bit rate and the first estimated viewing duration.

12. The electronic device of claim 11, wherein determining the target cache progress according to the target network speed value, the video bit rate and the first estimated viewing duration comprises:
determining a maximum value of a third preset value and a fourth sub-value as a first candidate cache progress, wherein the fourth sub-value is determined based on a fourth preset value, the target network speed value, the video bit rate and the first estimated viewing duration; and
determining the target cache progress according to the first candidate cache progress, a preset minimum cache progress and a preset maximum cache progress.

13. The electronic device of claim 12, wherein determining the target cache progress according to the first candidate cache progress, the preset minimum cache progress and the preset maximum cache progress comprises:
taking a sum value of the first candidate cache progress and the minimum cache progress as a second candidate cache progress; and
taking a minimum value of the second candidate cache progress and the maximum cache progress as the target cache progress.

14. The electronic device of claim 9, wherein obtaining the first estimated viewing duration and the second estimated viewing duration comprises:
inputting the current play progress into the play duration prediction model, to obtain the first estimated viewing duration and the second estimated viewing duration.

15. A non-transitory computer-readable storage medium, wherein the computer-readable storage medium stores computer-executable instructions, and a processor, when executing the computer-executable instructions, implements a video caching method comprising:
obtaining a video bit rate corresponding to a video to be cached, lag data of a plurality of downloaded videos, an estimated network speed value and a first estimated viewing duration, wherein the first estimated viewing duration is obtained by inputting a current play progress of the video to be cached into a play duration prediction model, the estimated network speed value is determined based on network speed values of a plurality of pieces of downloaded data during download, and the play duration prediction model is obtained through training based on a plurality video play data;
determining a target cache progress of the video to be cached according to the video bit rate, the lag data, the estimated network speed value and the first estimated viewing duration; and
controlling a cache progress of the video to be cached according to the target cache progress.

16. The non-transitory computer-readable storage medium of claim 15, wherein the method further comprises:
updating the target cache progress according to a second estimated viewing duration and a preset first trust factor for evaluating reliability of the second estimated viewing duration, to obtain an updated target cache progress, wherein the second estimated viewing duration is obtained by inputting the current play progress into the play duration prediction model, and the second estimated viewing duration output by the play duration prediction model has a probability of occurrence greater than that of the first estimated viewing duration; and
controlling the cache progress of the video to be cached according to the updated target cache progress.

17. The non-transitory computer-readable storage medium of claim 16, wherein updating the target cache progress according to the second estimated viewing duration and the preset first trust factor for evaluating the reliability of the second estimated viewing duration comprises:
in response to the first trust factor being greater than a first preset value and smaller than a second preset value, updating the target cache progress to a first value, wherein the first value is a sum of a first sub-value and a second sub-value, the first sub-value is a product of the first trust factor and the second estimated viewing duration, the second sub-value is a product of the target cache progress and a third sub-value, the third sub-value is a difference between 1 and the first trust factor, and the second preset value is greater than the first preset value; and
in response to the first trust factor not being greater than the first preset value or not being smaller than the second preset value, updating the target cache progress to a second value, wherein the second value is a maximum value of the target cache progress and the second estimated viewing duration.

18. The non-transitory computer-readable storage medium of claim 15, wherein determining the target cache progress of the video to be cached according to the video bit rate, the lag data, the estimated network speed value and the first estimated viewing duration comprises:
determining a target network speed value according to the estimated network speed value, a preset second trust factor for evaluating reliability of the estimated network speed value, the lag data and an influencing factor of the lag data on the target network speed value; and
determining the target cache progress according to the target network speed value, the video bit rate and the first estimated viewing duration.

19. The non-transitory computer-readable storage medium of claim 18, wherein determining the target cache progress according to the target network speed value, the video bit rate and the first estimated viewing duration comprises:
determining a maximum value of a third preset value and a fourth sub-value as a first candidate cache progress, wherein the fourth sub-value is determined based on a fourth preset value, the target network speed value, the video bit rate and the first estimated viewing duration; and
determining the target cache progress according to the first candidate cache progress, a preset minimum cache progress and a preset maximum cache progress.

20. The non-transitory computer-readable storage medium of claim 19, wherein determining the target cache progress according to the first candidate cache progress, the preset minimum cache progress and the preset maximum cache progress comprises:
taking a sum value of the first candidate cache progress and the minimum cache progress as a second candidate cache progress; and
taking a minimum value of the second candidate cache progress and the maximum cache progress as the target cache progress.
